(19) United States
(12) Patent Application Publication
(10) Pub. No.: US 2006/0190590 A1
(43) Pub. Date: Aug. 24, 2006

(54) Home network system and method for providing information therein

(75) Inventor: Hyung-gon Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO LTD

(21) Appl. No.: 11/316,964

(22) Filed: Dec. 27, 2005

(30) Foreign Application Priority Data
Feb. 22, 2005 (KR) 2005-14559

(51) Int. Cl. G06F 15/173

(52) U.S. Cl. 709/224

(57) ABSTRACT

A home network system and a method of providing information in the home network system, wherein the home network system includes a sensor network tracking the location of a user in real time and transmitting location information of the user, a plurality of information terminals providing predetermined information to the user, and a home server receiving the location information from the sensor network and transmitting the predetermined information to the user, by selecting at least one of the plurality of information terminals by using the location information.

### CROSS-REFERENCE TO RELATED APPLICATIONS

This application claims priority from Korean Patent Application No. 2005-14559, filed on Feb. 22, 2005, the entire content of which is incorporated herein by reference.

### BACKGROUND OF THE INVENTION

1. Field of the Invention

Home network systems and methods consistent with the present invention relate to providing information therein.

2. Description of the Related Art

A home network employs a physical network technique which connects information electronic appliances in a home through a network and thus, permits free use of the electronic appliances without regard to time and place. The targets to be constructed by a home network are not analog devices, but digital devices such as a refrigerator, a washing machine, a digital TV, a digital camcorder, a camera, a computer, a notebook computer, an air conditioner, etc., operable by an Internet.

If a home network is installed, a user in an inner room can check whether a person is ringing a doorbell, whether washing is finished, and whether rice is boiled in an electric rice pot, as well as various information provided from external web servers through an Internet network.

However, in order to check such information, a user must move to the place where information terminals displaying information, such as a digital TV, a computer and a notebook computer, etc., are located. Also, in order to control various devices connected to the home network system, a user suffers the inconvenience of having to move to the place where various input devices, such as a remote controller, a keyboard, a mouse, etc., are located.

Also, there are problems when a home server should provide a user with important information in real time. If there is no information terminal in the place where a user is located, the home server cannot provide the corresponding information in time

### SUMMARY OF THE INVENTION

The present invention provides a home network system and a method for providing information therein, capable of allowing a user to immediately check information provided from a home server and control various devices connected to a home network at the user's current location in a home.

The home network system according to an exemplary embodiment of the present invention includes: a sensor network tracking a location of a user in real time and transmitting the corresponding location information; a plurality of information terminals providing predetermined information to users; and a home server receiving the location information of the users from the sensor network and selecting at least one among the plurality of information terminals using the location information.

The information terminals include a display portion displaying the information transmitted from the home server.

Also, in an exemplary embodiment, the display portion displays the transmitted information when there is information transmitted from the home server and the display portion operates as permeability media or a mirror reflecting the user's image when there is no information transmitted from the home server.

The home server includes a terminal information storing portion storing the location information of the plurality of information terminals and a home server control portion comparing the user's location information transmitted from the sensor network with the locations of the plurality of the information terminals stored in the terminal information storing portion for selecting the information terminal which will transmit information to the user.

The home server control portion can select an information terminal, which is located closest to the user's location, among the plurality of information terminals.

Another home network system according to an exemplary embodiment of the present invention includes a display portion displaying information transmitted from the home server; and a terminal control portion obtaining a user authentication by transmitting a predetermined voice command to the home server when the voice command is input by the user and displaying a user interface (UI) screen transmitted from the home server on the display portion.

In an aspect of the present invention, the display portion displays the transmitted information when there is information transmitted from the home server and the display portion operates as permeability media or a mirror reflecting the user's image when there is no information transmitted from the home server.

The home server includes a voice recognition authorizing portion performing a user authentication by analyzing a voice command transmitted from the information terminal; and a UI processing portion providing a predetermined UI screen for the authorized user to the information terminal when the user authentication on the transmitted voice command is obtained.

A method for providing information in the home network system according to an exemplary embodiment of the present invention includes: receiving the information requested to be transmitted to predetermined users; checking the user's location information so that the user can receive the information; selecting at least one among a plurality of information terminals through the user's location information; and providing the information to the user by transmitting the information to the selected at least one information terminal.

Also, in an exemplary embodiment, the information terminal located closest to the user's location is selected among the plurality of information terminals.

In an exemplary embodiment, the plurality of information terminals display the transmitted information when there is information transmitted from the home server and the plurality of information terminals operate as permeability media or a mirror reflecting the user's image when there is no information transmitted from the home server.

### BRIEF DESCRIPTION OF THE DRAWINGS

FIG. 1 is a schematic diagram showing a home network system including a plurality of information terminals and a home server according to an exemplary embodiment of the present invention;

FIG. 2 is a detailed block diagram showing a first information terminal among the plurality of information terminals shown in FIG. 1;

FIG. 3 is a block diagram showing a home server according to an exemplary embodiment of the present invention;

FIG. 4 is a flowchart showing a method for providing information in a home network system according to a first exemplary embodiment of the present invention; and

FIG. 5 is a flowchart showing a method for providing information in a home network system according to a second exemplary embodiment of the present invention.

### DETAILED DESCRIPTION OF THE EXEMPLARY EMBODIMENTS

Referring now to the appended drawings, the exemplary embodiments according to the present invention are explained as follows:

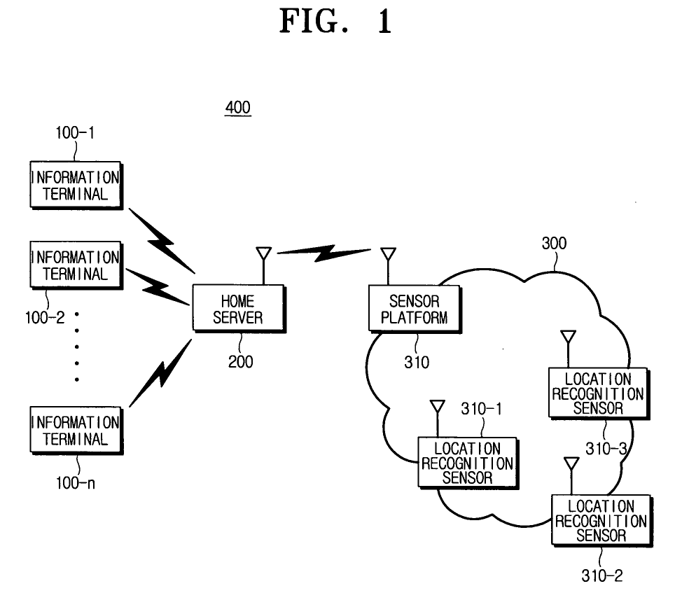

FIG. 1 is a schematic diagram showing a home network system including information terminals and a home server according to an exemplary embodiment of the present invention.

Referring to FIG. 1, the home network system 400 according to an exemplary embodiment of the present invention includes a plurality of information terminals 100-1, 100-2, . . . , 100-n, a sensor network 300 and a home server 200, which are connected to an Internet network by a home RF using Radio Frequency (RF), Bluetooth, wireless LAN, IrDA using infrared rays, etc. Also, although not shown in the drawing, the home network system 400 may include digital devices such as a refrigerator, a washing machine, a digital TV, a digital camcorder, a camera, a computer, a notebook computer, an air conditioner, etc., which are capable of being operated by an Internet.

The sensor network 300 collects the locations and identities of users at home and transmits them to the home server 200. A method for checking the locations of users at home can include a method for attaching a Radio Frequency TAG (RF TAG) to the respective users and checking the locations of the users at home through the RF TAG location recognition sensors 310-1, 310-2, 310-3 installed in respective locations (e.g., room, living room, bath room, kitchen, etc.) in a home. Here, the RF TAG location recognition sensors 310-1, 310-2, 310-3 check the location information of users in real time and provide the location information of the users to the home server 200 through a sensor platform 310. Also, when the information terminals 100-1, 100-2, . . . , 100-n are attached with an RF TAG, it is also possible that the sensor network 300 checks the location information of the information terminals 100-1, 100-2, . . . , 100-n and transmits the location information of the information terminals to the home server 200.

Also, it is possible to implement a check on the identities and the locations of users by analyzing, in the home server 200, the images picked-up and transmitted by the web cameras, after installing a plurality of web cameras (not shown) in respective locations in a home. Also, the sensor network 300 includes a temperature sensor (not shown), a noise sensor (not shown) and an illuminance sensor (not shown), etc., and can provide information such as temperature, noise and illuminance, and the like in the respective locations in a home to the home server 200.

At normal times, a plurality of the information terminals 100-1, 100-2, . . . , 100-n operate as permeability media such as a glass plate of a table in the living room, a window in the inner room, a shower glass plate in the bath room, or as a mirror reflecting the user's image, while they are installed in respective locations in a home. The information terminals 100-1, 100-2 . . . , 100-n include a display portion (not shown) displaying the corresponding images and letters when predetermined information is transmitted from the home server 200 or a predetermined command is input by a user.

The home server 200 receives the user's current location information from the sensor network 300 so that the user can check predetermined information at the user's current location. In addition, the home server 200 transmits the corresponding information by selecting at least one among a plurality of information terminals 100-1, 100-2, . . . , 100-n using the user's location information. Also, the home server 200 plays a role as a gateway connected to external networks such as an Internet network (not shown) or the home server 200 can communicate with the external networks through a separate gateway (not shown) installed on the outside of the home server 200.

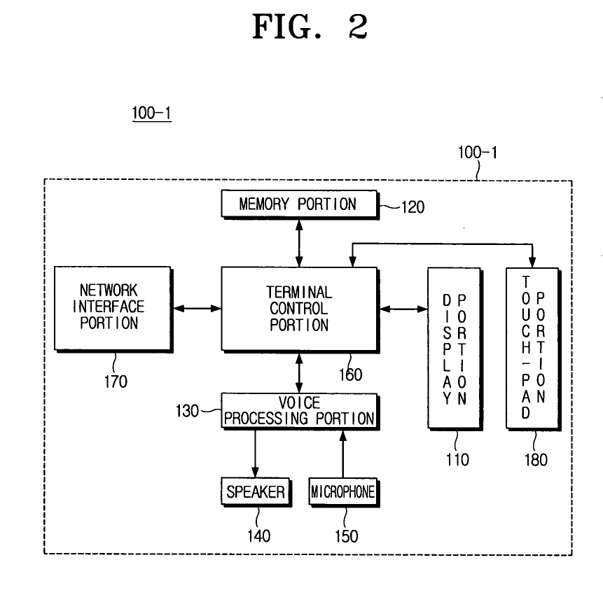

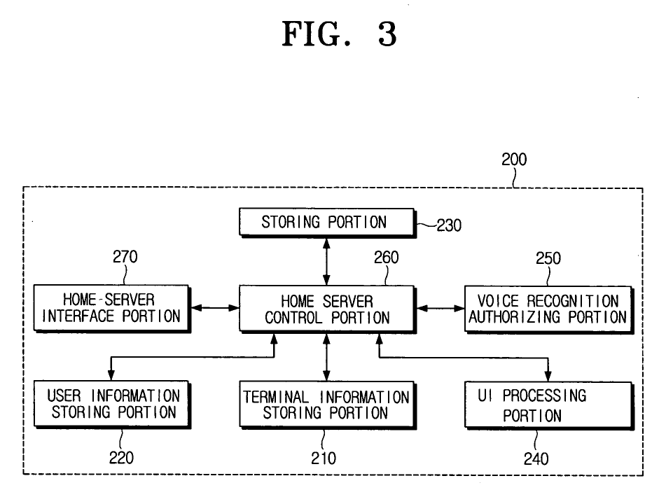

The constitution and the operation of the information terminals 100-1, 100-2, . . . , 100-n and the home server 200 according to an exemplary embodiment of the present invention will be described below in detail with reference to FIG. 2 and FIG. 3.

FIG. 2 is a detailed block diagram showing a first information terminal among a plurality of the information terminals shown in FIG. 1. Referring to FIG. 2, the first information terminal 100-1 includes a display portion 110, a memory portion 120, a touchpad portion 180, a voice processing portion 130, a speaker 140, a microphone 150, a network interface portion 170 and a terminal control portion 160. The display portion 110 displays the information data or the user interface screen transmitted from the home server 200 by means of the control of the terminal control portion 160. In particular, the display portion according to an exemplary embodiment of the present invention operates as permeability media, such as a glass or a mirror reflecting the user's image, when there is no information transmitted from the home server 200. Thereby, the display portion 110 of the first information terminal 100-1 can provide a user with information by being installed in respective locations in a home, such as a table in the living room, a window in the inner room, a shower glass plate in the bath room and a wall mirror, without occupying separate spaces in a home.

The memory portion 120 stores a control program required for implementing the function of the first information terminal 100-1 and various data generated during the operation of the first information terminal 100-1

The voice processing portion 130 converts a voice data signal input from the home server 200 through the network interface portion 170 into a voice and outputs it through a speaker 140, or converts the user's voice input from the microphone 150 into a voice data signal and provides it to the home server through the network interface portion 170. Also, the voice processing portion 130 can include the voice recognition processing function for converting the voice input through the microphone 150 into letters.

The terminal control portion 160 controls the overall operations of the first information terminal 100-1, in particular, the terminal control portion 160 according to an exemplary embodiment of the present invention switches the display portion 110 from a normal mode in the state of a mirror or permeability media to a display mode, when a predetermined information data is transmitted from the home server, thereby displaying the screen corresponding to the transmitted information data. Also, the home server 200 receives the user command input through the microphone 150 or touchpad portion 180 so that the home server 200 can perform the job according to the user command.

The network interface portion 170, such as a Universal Serial Bus (USB) port, wireless module, etc., can be provided for connecting the first information terminal 100-1 to the external apparatus. In particular, according to an exemplary embodiment of the present invention, the network interface portion 170 connects to the home server interface portion 270 and thereby, plays a path role to exchange data to each other.

The touchpad portion 180 is installed in front of the display portion 110 to detect the signal corresponding to a touch input through a user's hand or a pen, and the like and transmits the signal to the terminal control portion 160.

FIG. 3 is a block diagram showing the home server according to an exemplary embodiment of the present invention. The home server 200 includes a terminal information storing portion 210, a user information storing portion 220, a storing portion 230, a UI processing portion 240, a voice recognition authorizing portion 250, a home server control portion 260 and a home server interface portion 270.

According to an exemplary embodiment of the present invention, the terminal information storing portion 210 stores the location information of a plurality of the information terminals 100-1, 100-2, . . . , 100-n in a home. The user information storing portion 220 registers and stores the users' identity information within the home network system according to an exemplary embodiment of the present invention. For example, the respective users' names, RF TAG information, users' voice information, image information for user authentication, and the like can be stored.

The storing portion 230 stores a control program required for implementing the function of the home server 200 and various data generated during the operation of the home server 200.

The UI processing portion 240 stores the user interface screens, which are previously set for every user, and provides the user interface screen for the corresponding user, depending on the user's identity information authorized by the voice recognition authorizing portion 250, to the information terminals 100-1, 100-2, . . . , 100-n.

The voice recognition authorizing portion 250 recognizes a user's voice command transmitted from the information terminals 100-1, 100-2, . . . , 100-n and compares it with the user voice stored in the user information storing portion 220 in order to perform the user authentication and transmits the authentication results to the home server control portion 260.

The home server control portion 260 controls the overall operation of the home server 200. Also, when the information requested to be transmitted to a specific user is transmitted from the external networks through an Internet network (not shown) or generated within the home network system, the home server control portion 260 checks which location the user is located in a home by using the user location information and identity information provided from the sensor network 300, compares it with the location information of the information terminals 100-1, 100-2, . . . , 100-n stored in the terminal information storing portion 210, and then selects the information terminal which will transmit the corresponding information by means of a predetermined method.

Here, as a method for selecting the information terminal, the following two methods can be used: a method for selecting the information terminal located closest to the user's location, and a method for selecting the information terminal belonging to the area on which the user is now located by dividing the respective locations in a home by every predetermined area.

Also, if a user's voice command is transmitted from the information terminals 100-1, 100-2, . . . , 100-n and thus, the user's identity is authorized from the voice recognition authorizing portion 250, the home server control portion 260 processes the user interface screen for the corresponding user using the UI processing portion 240 and transmits it to the corresponding information terminal.

The home server interface portion 270, such as USB port, wireless module, etc., can be provided for connecting the home server 200 to the external apparatus. In particular, according to an exemplary embodiment of the present invention, the home server interface portion 270 connects to the network interface portion 170 of the information terminal and thereby plays a path role to exchange data to each other and also plays a role to connect the home server 200 to the sensor network 300 and the Internet network.

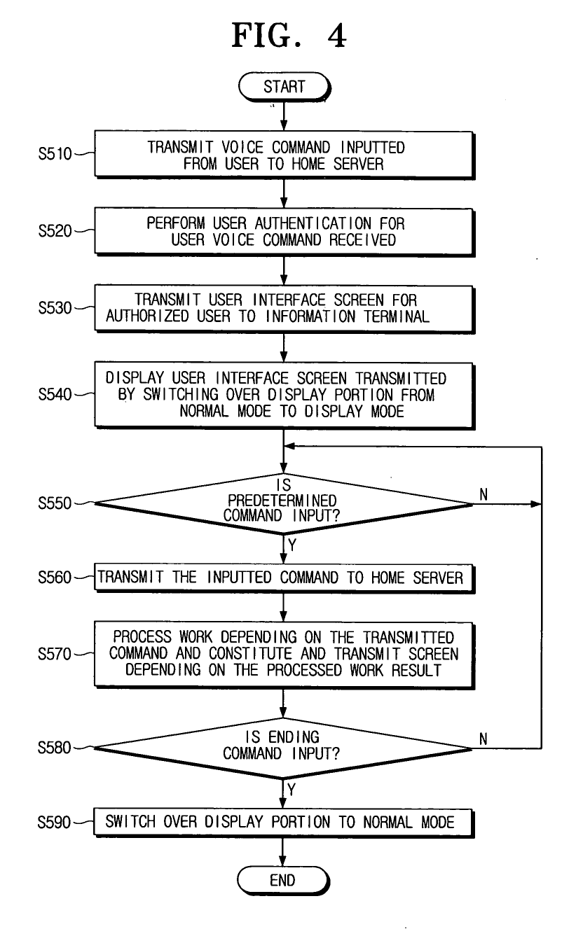

FIG. 4 is a flowchart showing a method for providing information in the home network system according to the first exemplary embodiment of the present invention. Referring to FIGS. 1 to 4, if the voice command for operating the information terminal 100-1 from the user is input through the microphone 150, the information terminal 100-1 converts the input voice command into voice data in the voice processing portion 130 and transmits the voice data to the home server 200 in S510.

Thereafter, the home server 200 recognizes the received user voice command in the voice recognition authorizing portion 250 and compares it with the user voice stored in the user information storing portion 220 in order to perform the identity authentication for a user in S520. Next, the home server 200 generates the user interface screen for the authorized corresponding user in the UI processing portion 240 and transmits it to the information terminal 100-1 in S530.

Thereafter, the terminal control portion 160 makes the display portion 110, which was operating in normal mode as permeability media, such as a glass or a mirror reflecting the user's image, into a display mode for displaying the information received from the home server 200 in S540.

Next, if a predetermined command is input by the user through the touchpad portion 180 or the microphone 150 in S550, the terminal control portion 160 transmits the command input through the network interface portion 170 to the home server 200 in S560. Here, the command input by the user can be a checking command on the operation conditions of electronic appliances, and the like connected to the home network or a retrieving command on desired information from an external web-server, etc.

Thereafter, the home server 200 processes a job depending on the user command transmitted from the information terminal 100-1, and constitutes the screen for providing the user with the processed job results and transmits it to the information terminal 100-1 for displaying it on the display portion 110 of the information terminal 100-1 in S570.

Finally, if a display mode ending command of the information terminal 100-1 is input by the user through the touchpad 180 or the microphone 150 in S580, the terminal control portion 160 switches over the display portion 110 to a normal mode making operation as permeability media such as a glass or as a mirror reflecting the user's image from the display mode for displaying the user interface screen transmitted from the home server 200 in S590.

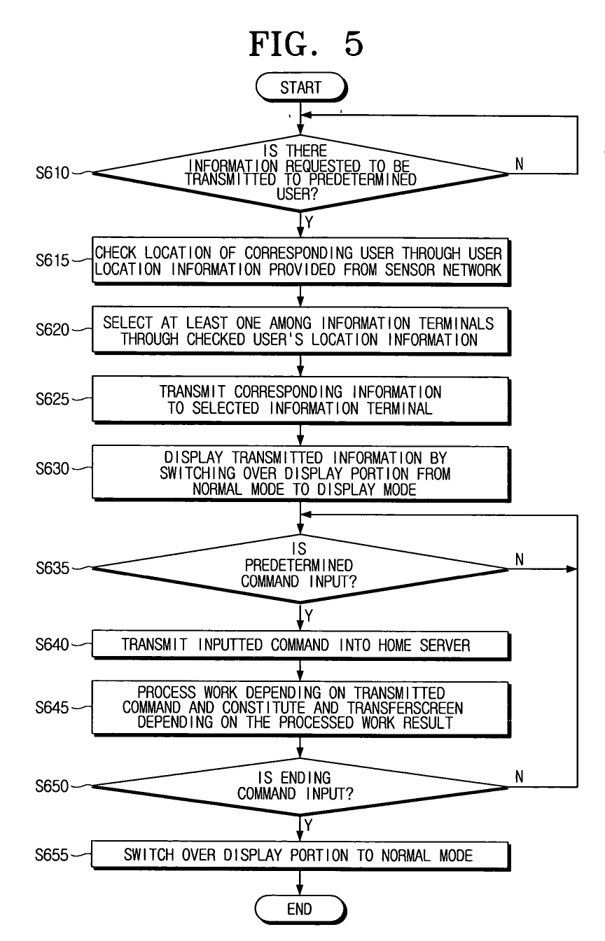

FIG. 5 is a flowchart of a method for providing information in the home network system according to the second exemplary embodiment of the present invention. Referring to FIGS. 1 to 3 and FIG. 5, if the information requested to be transmitted to a specific user is transmitted from the external network through an Internet network (not shown) or generated within the home network system in S610, the home server control portion 260 checks which location the user is located in a home using the user location information and identity information provided from the sensor network 300 in S615. The home server control portion then compares the user location information with the location information of the information terminals 100-1, 100-2, . . . , 100-n stored in the terminal information storing portion 210 and then selects the information terminal which will transmit the corresponding information by means of a predetermined method in S620, and transmits the corresponding information to the selected information terminal in S625.

Here, as a method for selecting the information terminal, similar to the first exemplary embodiment, the following two methods can be used: a method for selecting the information terminal located closest to the user's location, and a method for selecting the information terminal belonging to the area on which the user is now located by dividing the respective locations at home by every predetermined area.

The terminal control portion 160 switches over the display portion 110 from a normal mode making operation as permeability media such as a glass or as a mirror reflecting the user's image to a display mode for displaying the information transmitted from the home server 200 in S630.

Next, if a predetermined command is input by the user through the touchpad portion 180 or the microphone 150 in S635, the terminal control portion 160 transmits the command input through the network interface portion 170 to the home server 200 in S640. Here, the command input by the user can be any command notifying that the user checks the information transmitted from the home server, additionally requesting new information, requesting a check on the operation condition of another electronic appliance, etc.

Thereafter, the home server 200 processes a job depending on the user command transmitted from the information terminal, constitutes the screen for providing the user with the processed job results, and transmits it to the corresponding information terminal for displaying it on the display portion 110 in S645.

Finally, if a display mode ending command of the information terminal is input by the user through the touchpad 180 or the microphone 150 in S650, the terminal control portion 160 switches over the display portion 110 to a normal mode making operation as permeability media such as a glass or as a mirror reflecting the user's image in S655.

As described above, the exemplary embodiments of the present invention have the advantage that a user can immediately check the information provided from the home server and control various devices connected to the home network at the user's current location in a home.

Also, the exemplary embodiments of the present invention have another advantage in that they can provide a user with information in the respective locations in a home, without occupying any separate spaces by installing the display portion operating as permeability media, a mirror reflecting the user's image, a table in the living room, a window in the inner room, a shower glass plate in the bath room, a wall mirror, etc.

As above, the exemplary embodiments have been described in the detailed description of the present invention, however, various modifications may be implemented with respect to the foregoing description without departing from the scope of the present invention. Thus, the present invention is not limited to the particular exemplary embodiments described herein, but rather is limited only by the following claims and their equivalents.

What is claimed is:

1. A home network system, comprising:
a sensor network tracking a location of a user in real time and transmitting a location information of the user;
a plurality of information terminals providing predetermined information to the user; and
a home server receiving the location information of the user from the sensor network and transmitting the predetermined information to the user, by selecting at least one of the plurality of information terminals by using the location information of the user.

2. The home network system according to claim 1, wherein each information terminal comprises a display portion displaying the information transmitted from the home server.

3. The home network system according to claim 2, wherein the display portion displays the transmitted information when there is information transmitted from the home server and serves as a permeable medium when there is no information transmitted from the home server.

4. The home network system according to claim 2, wherein the display portion displays the transmitted information when there is information transmitted from the home server and serves as a mirror reflecting an image of the user when there is no information transmitted from the home server.

5. The home network system according to claim 1, wherein the home server comprises:
a storing portion storing the location information of the plurality of information terminals; and
a home server control portion comparing the user's location information transmitted from the sensor network with the locations of the plurality of information terminals stored in the terminal information storing portion to select the information terminal which would transmit the information to the user.

6. The home network system according to claim 5, wherein the home server selects the information terminal which is located closest to the user's location, among the plurality of information terminals.

7. A home network system for providing a user with predetermined information transmitted from a homeserver using at least one terminal and controlling the terminal, wherein the at least one terminal comprises:
a display portion which displays the predetermined information transmitted from the home server; and
a terminal control portion which obtains a user authentication by transmitting a predetermined voice command to the home server when the voice command is input by the user and displaying a User Interface (UI) screen transmitted from the home server on the display portion.

8. The home network system according to claim 7, wherein the display portion serves as a display unit when there is information transmitted from the home server and serves as a permeable medium when there is no information transmitted from the home server.

9. The home network system according to claim 7, wherein the display portion serves as a display unit when there is information transmitted from the home server and serves as a mirror reflecting a user's image thereon when there is no information transmitted from the home server.

10. The home network system according to claim 7, wherein the home server comprises:
a voice recognition authorizing portion which performs a user authentication by analyzing a voice command transmitted from the terminal; and
a UI processing portion providing a predetermined UI screen for an authorized user to the terminal when the user authentication on the transmitted voice command is obtained.

11. A method for providing information in a home network system comprising a plurality of information terminals and a home server for providing predetermined information, comprising:
receiving information requested to be transmitted to predetermined users;
checking location information on the user to receive the predetermined information;
selecting at least one of a plurality of information terminals by using the location information; and
providing the information requested to the user by transmitting the information requested to the selected at least one information terminal.

12. The method according to claim 11, wherein the information terminal located nearest to the user's location is selected among the plurality of information terminals.

13. The method according to claim 12, wherein the plurality of information terminals displays the transmitted information when there is information transmitted from the home server and serves as a permeable medium when there is no information transmitted from the home server.

14. The method according to claim 12, wherein the plurality of information terminals displays the transmitted information when there is information transmitted from the home server and serves as a mirror reflecting a user's image when there is no information transmitted from the home server.

15. A home server which transmits predetermined information to a user through one of a plurality of information terminals in a home network system, the home server comprising:
a storing portion storing a location information of the plurality of information terminals; and
a home server control portion comparing a user's location information transmitted from a sensor network with the locations of the plurality of information terminals stored in the terminal information storing portion to select the information terminal which would transmit the information to the user.

16. The home server according to claim 15, wherein the home server selects the information terminal which is located closest to the user's location, among the plurality of information terminals.

17. The home server according to claim 15, further comprising:
a voice recognition authorizing portion which performs a user authentication by analyzing a voice command transmitted from the information terminal; and
a UI processing portion providing a predetermined UI screen for an authorized user to the selected information terminal when the user authentication on the transmitted voice command is obtained.

18. An information terminal which provides predetermined information transmitted from a home server to a user in a home network system, the information terminal comprising:
a display portion which displays the predetermined information transmitted from the home server; and
a terminal control portion which obtains a user authentication by transmitting a predetermined voice command to the home server when it is input by the user and displaying a UI screen transmitted from the home server on the display portion.

19. The information terminal according to claim 18, wherein the display portion displays the transmitted information when there is information transmitted from the home server and serves as a permeable medium when there is no information transmitted from the home server.

20. The information terminal according to claim 18, wherein the display portion displays the transmitted information when there is information transmitted from the home server and serves as a mirror reflecting an image of the user when there is no information transmitted from the home server.
